(19) United States
(12) Patent Application Publication
(10) Pub. No.: US 2014/0030633 A1
(43) Pub. Date: Jan. 30, 2014

(54) Metal Seal Having Ceramic Core

(71) Applicants: Francois Palermo, Lapalud (FR); Lionel Bruguiere, Saint Aunes (FR)

(72) Inventors: Francois Palermo, Lapalud (FR); Lionel Bruguiere, Saint Aunes (FR)

(73) Assignees: COMMISSARIAT A L'ENERGIE ATOMIQUE ET AUX ENERGIES ALTERNATIVES, Paris (FR); TECHNETICS GROUP FRANCE SAS, Saint Etienne (FR)

(21) Appl. No.: 14/111,588

(22) PCT Filed: Apr. 19, 2012
(86) PCT No.: PCT/EP12/57136

§ 371 Date: Oct. 14, 2013

(30) Foreign Application Priority Data
Apr. 22, 2011 (FR) 11 535519

(51) Int. Cl. H01M 8/02; C25B 9/00

(52) U.S. Cl. CPC H01M 8/0282; C25B 9/00
USPC 429/510; 204/279

(57) ABSTRACT

The seal comprises a centre layer (5) of electrically insulating material, two metal outer layers (6, 7) bearing patterns (8, 9) able to be deformed by flattening out on the bearing faces (2, 3) to be sealed, so as to hold the seal while providing a sealing barrier to the connections, and intermediate layers (10, 11) of glassy material to provide connection thereto while absorbing deformations due to differential expansions.

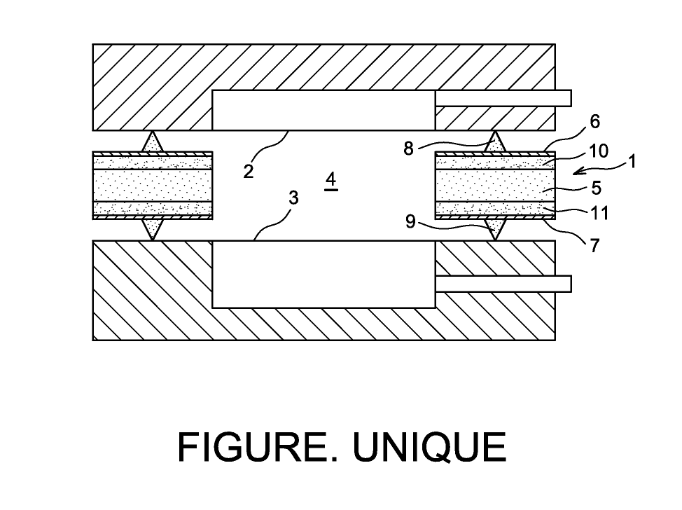

Applicable to high temperature electrolysis or fuel cells.

### TECHNICAL FIELD

The object of the invention is a seal having metal faces, a significant property of which is that it is an electrical insulator.

Applications mainly relate to hydrogen generation by dissociation of the water molecule (H₂O) in a high temperature electrolyser called HTE and/or electrical power generation from a fuel gas in SOFC (Solid Oxide Fuel Cell) type fuel cells, but these uses are not exhaustive. In both cases, electrochemical cells used in these production processes are brought to a high temperature.

### STATE OF THE ART

There are three main elements at the heart of the process of a high temperature water vapour electrolyser.

Electrochemical cells consist of three layers, two porous electrode layers, a cathode and an anode, on either side of a dense electrolyte. This electrolyte, most often a ceramics, becomes an ionic conductor when a suitable voltage is applied thereto.

Two interconnectors, an anodic one and a cathodic one respectively connected to the anode and cathode, are contacting the porous electrodes of the cell. They can be in contact with the cell electrolyte through a seal to seal the anodic and cathodic chambers.

In the principle of operation, water as vapour is dissociated when contacting the cathode. Hydrogen is formed on a cathodic side whereas oxygen ions are conveyed via the electrolyte (ionic conductor) to the anodic compartment where they are recombined at the electrode.

The conveyance and exhaust of the fluids require numerous sealings to be realised between the different elements of the electrolyser to prevent hydrogen and oxygen from recombining and gas produced from leaking outside the electrolyser.

Two types of site to be sealed are identified, a metal/metal interface between the interconnectors where it is imperative to have an electrically insulating seal and a metal/ceramics interface which requires a seal accommodating shear during thermal transients due to the difference in thermal expansion coefficients of these materials; the types of metals employed in an electrolyser tending to expand more than ceramics elements.

The presence of fragile materials such as the cell electrolyte results in restricting stresses and thus tightening strains of this seal.

In the medium and long term, other elements such as the demountability and recyclability aspects of the interconnectors are also to be considered.

The seals present at the clearances of the cells should retain a good sealing at high temperatures, of several hundreds degrees Celsius, to which there are likely to be brought. The variations in temperature cannot only damage most usual materials but also generate a high shear to the seal by differential expansions of both bearing faces between which it is placed, or by heterogeneous temperatures in the cell. Another requirement to be respected is that the seal should be electrically insulating.

Most materials do not have these properties. Materials hardly liable to be damaged at high temperatures are often mechanically fragile and thus low in shear strength, whereas materials that are ductile or likely to be cracked without being broken through shearing are likely to have insufficient sealing properties. All these materials are often damaged at high temperatures as well, losing their initial properties, making them useless. Many of them are not electrically insulating. Finally, some of them are sensitive to corrosion by the cell atmosphere.

Today, there is no seal meeting all the criteria required for this type of application.

The seal that is most similar to our invention is being filed under the title “Joint d'étanchéité entre deux éléments à coefficients de dilatation thermique différents” and for N° E.N.: 09 57344. This is a metal seal, its main advantage as is suggested by its title is the accommodation to thermal expansions, however its manufacture is complex. Furthermore, it is electrically conducting, therefore it cannot be placed between two interconnectors of a high temperature water vapour electrolyser.

So called compressive seals, typically of mica, are disintegrated over time and often require significant tightening strains.

Solder-based seals have problems of chemical compatibility with the environment of a high temperature electrolyser.

Seals of glassy or glass ceramic material generally result in the breakage of the cell upon opening the electrolyser for maintenance for example because once the seal is formed, it strongly adheres to the bearing faces and results in breaking up the cell electrolyte. The interconnectors are scarcely reusable because of the deposit left behind by this type of material onto the bearing faces. Generally, the seals of glassy or glass-ceramic material do not facilitate the demounting and recover of the main elements of a high temperature water vapour electrolyser.

### DISCLOSURE OF THE INVENTION

The seal object of the present invention has a combination of layers of different materials which obviates these drawbacks and can be used to seal cells at 800° C. for example, with sealing rates in the order of 2.10⁻⁵ Pa·m3·s⁻¹ for several hundreds millibars, or even 1 bar of pressure difference. It is electrically insulating and its corrosion resistance is sufficient. It is easily and properly demountable.

In a general form, it relates to a seal for working at an operating temperature of several hundreds degrees Celsius, characterised in that it comprises, on either side of an electrically insulating centre layer, an outer metal layer provided with a pattern for anchoring to a bearing face to be sealed, and a binder layer between the outer layer and the centre layer, the binder layer being of glassy or glass-ceramic material at the operating temperature.

The invention will now be described in connection with the FIGURE. The seal 1 is compressed between two planar bearing faces 2 and 3 facing each other. It aids in sealing a cell 4 further bounded by pieces comprising the bearing faces 2 and 3. It can extend on a circle, a polygon or any other line.

The seal 1 is first formed by a centre layer 5 of an electrically insulating material and selected for its low permeability to gas diffusion and its great chemical inertia to corrosive atmospheres. This core layer has a thickness adaptable to the housing dedicated to the seal.

The outer faces of the seal are formed by two metal layers or washers 6 and 7 respectively located facing the bearing faces 2 and 3 and in the middle of which are raised patterns 8 and 9 having a triangular cross-section and the tip of which is contacting the respective bearing face 2 or 3. When the tightening strain required to provide sealing is however applied, these tips are flattened out and their material comes into close contact with those of the bearing faces 2 and 3, which aids in setting a good sealing at this place. The tightening is not accompanied by an excessive compression of the seal 1, the deformations being concentrated to the patterns 8 and 9 of ductile material.

Binder layers 10 and 11 connect the metal layers 6 and 7 to the core centre layer 5. They are of glassy material, for example of glass that does not exhibit crystallization at the temperature reached in operation, or of glass-ceramics. The binder layers 10 and 11 can be of the same or different nature on a same seal element depending on the contacting bearing faces.

The stack of layers consisting of the metal washers 6 and 7, the binder 10 and 11 and the core 5 has, besides their function of radially and axially sealing the system, that of absorbing shears due to expansion differences of the bearing faces 2 and 3.

The different layers can be made from strips, such that manufacturing the seal amounts to cutting off and assembling the layers and that it is therefore simple, in particular without any welds. The overall space of the seal is reduced. Its demounting and replacement are easy. Their impact on the environment, that is the bearing faces 2 and 3, is only moderate and do not induce any significant changes for the recycling thereof.

Some suitable materials are:
for the core centre layer 5: ideally an yttried zirconia type ceramics (YSZ) common to the centre element of the electrochemical cells, the glass ceramic Macor® readily machinable and having a thermal expansion coefficient close to that of the zirconia and of the metal materials of interconnectors, but alumina (Al₂O₃) could also be contemplated for example for other applications;
for the outer metal layers 6 and 7: iron-, chromium- and aluminium-based alloys of the OC404 type marketed under the trade name FeCrAlloy or even superelastic alloys such as Inconel 718 SPF;
for the intermediate binder layers 10 and 11: high-silicon sodium and aluminum borosilicate glasses, such as JV36 from CEA; calcium aluminosilicate glass-ceramics such as CAS from CEA; commercial solutions from Schott, 8422 (glass), G018-304 (glass-ceramic).

Generally, these trademarks are registered.

1. A seal (1) for working at an operating temperature of several hundreds degrees Celsius, characterised in that it comprises, on either side of an electrically insulating centre layer (5), an outer metal layer (6, 7) provided with a pattern (8, 9) for anchoring to a bearing face to be sealed, and a binder layer (10, 11) between the outer layer and the centre layer, the binder layer being of glassy or glass-ceramic material at the operating temperature.

2. The seal according to claim 1, characterised in that the binder layers (10, 11) are identical or different depending on the interfaces to be sealed.

3. The seal according to claim 1, characterised in that the patterns have a triangular cross-section with a tip pointed to the bearing face.

4. The seal according to claim 1, characterised in that the metal layers (6, 7) are thinner than the centre layer (12).

5. The seal according to claim 1, characterised in that the centre layer is in ceramics.

6. The seal according to claim 1, characterised in that the binder layers (10 and 11) and the centre layer are selected depending on the intermediate thermal expansion coefficients between the bearing faces (2 and 3).
